(19) United States
(12) Patent Application Publication
(10) Pub. No.: US 2025/0183443 A1
(43) Pub. Date: Jun. 5, 2025

(54) BATTERY PACK, METHOD FOR FORMING BATTERY PACK AND ELECTRIC VEHICLE

(71) Applicant: SHANGHAI XUAN YI NEW ENERGY DEVELOPMENT CO., LTD., Shanghai (CN)

(72) Inventors: Azad DARBANDI, Unterfoehring (DE); Qiang ZHANG, Anhui (CN); Junfeng WANG, Anhui (CN); Nengyi JIN, Anhui (CN); Tobias SCHMIEG, Anhui (CN); Qian CHENG, Anhui (CN); Chen LI, Anhui (CN)

(73) Assignee: SHANGHAI XUAN YI NEW ENERGY DEVELOPMENT CO., LTD., Shanghai (CN)

(21) Appl. No.: 18/839,096

(22) PCT Filed: Feb. 17, 2022
(86) PCT No.: PCT/CN2022/076640

§ 371 Date: Aug. 16, 2024

(51) Int. Cl. H01M 50/242; B60L 50/64; H01M 10/613; H01M 10/625; H01M 10/6554; H01M 50/204; H01M 50/249; H01M 50/271; H01M 50/293

(52) U.S. Cl. CPC H01M 50/242; H01M 10/613; H01M 10/625; H01M 10/6554; H01M 50/204; H01M 50/249; H01M 50/271; H01M 50/293; B60L 50/64; H01M 2220/20

(57) ABSTRACT

A battery pack, a method for forming a battery pack and an electric vehicle are provided. The battery pack includes a first pack cover, a second pack cover, and a cell module. The second pack cover is sealed with the first pack cover to form a cavity to accommodate the cell module. A first area on a first cover of the cell module is fixed onto the first pack cover by welding. A second area on the first cover of the cell module is fixed onto the first pack cover by glue.

### CROSS-REFERENCE TO RELATED APPLICATION

This application is a U.S. National Phase application of International Application No PCT/CN2022/076640, filed on Feb. 17, 2022, which is incorporated herein by reference in its entirety.

### TECHNICAL FIELD

Embodiments of the present disclosure generally relate to the field of battery, and more particularly, to a battery pack, a method for forming a battery pack and an electric vehicle.

### BACKGROUND

Nowadays, new energy electric vehicles (EV) has been developed rapidly. As a core component of EV application, Electric Energy Storage (EES) systems, the research on its related technology is more important. EES can also be called battery pack or Pack. In general, the Pack includes an upper cover, a lower cover and cell modules.

FIG. 1 is a diagram which shows a common Pack structure. As shown in FIG. 1, the Pack 10 includes an upper cover 11, a lower cover 12 and cell modules (not shown) located between the lower cover 12 and the upper cover 11. There are some bulges 13 on the upper cover which are used to fix the Pack into the vehicle underbody.

The prior art of mechanical design of EES systems for EV application consists of utilization of mechanical stabilizing structures e.g. bars within the EES. Those bars (either longitudinal or latitudinal) are not only responsible to absorb mechanical energy during crush situations (vehicle frontal or side crush) but also serve as fixation for cell modules.

FIG. 2 is a diagram which shows a Pack with latitudinal bars structure. As shown in FIG. 2, there are some latitudinal bars 201 (also called cross beam) and cell modules 202 inside the Pack. The latitudinal bars 201 can serve as fixation for cell modules 202 by the fixation points 203 and can also be responsible for absorbing the crush energy during vehicle side crash.

This section introduces aspects that may facilitate a better understanding of the disclosure. Accordingly, the statements of this section are to be read in this light and are not to be understood as admissions about what is in the prior art or what is not in the prior art.

### SUMMARY

However, the inventors found that: Longitudinal and/or latitudinal (cross) bars occupy up to parts (e.g. 15%) of the internal volume of the Pack. This leads to lower volumetric energy density of the EES, which in turn means higher costs per EES, lower installed energy and less electric driving range.

In order to overcome this drawback, the method of removing the mechanical structures (e.g. cross bars/longitudinal bars) from EES inside space and relocating those in other spaces e.g. into vehicle body (vehicle underbody plate structure) can be considered. Nevertheless, the inventors found that: by removing the Bars from EES, the Pack becomes mechanically unstable during shock and vibration loads.

One possibility to improve the mechanical stability in those EES (without bars) is to glue the cells/cell modules to the upper cover of the Pack and consider fixation points for EES upper cover into vehicle underbody structure. However, the inventors found that: mechanical properties of the structural glues are not sufficient to overcome the mechanical loads during shock and vibration, specially in z-axis.

In order to solve at least part of the above problems, methods and devices are provided in the present disclosure. Features and advantages of embodiments of the present disclosure will also be understood from the following description of specific embodiments when read in conjunction with the accompanying drawings, which illustrate, by way of example, the principles of embodiments of the present disclosure.

In general, embodiments of the present disclosure provide a cell pack. It is expected to realize of higher volumetric energy density by removing the structural bars from EES, fulfillment of mechanical requirements (shock and vibration) and strong bonding of cell module to EES upper cover, higher installed energy in EES, longer driving range of electric vehicle and lower costs per EES.

In a first aspect, a battery pack is provided at least including a first pack cover, a second pack cover and a cell module, the second pack cover sealed with the first pack cover to form a cavity to accommodate the cell module, wherein a first area on a first cover of the cell module is fixed onto the first pack cover by welding; a second area on the first cover of the cell module is fixed onto the first pack cover by glue.

In some embodiments, wherein the first area at least includes overhang area of a surface of the first cover of the cell module and/or uncoated area of a surface of the first cover of the cell module.

In some embodiments, wherein the second area is not overlapped with the first area.

In some embodiments, wherein a welding seam on the first area is in a line shape or in a zigzag shape.

In some embodiments, wherein the first area is located at intervals along the two sides of a part of the first cover of the cell module which corresponds to each cell.

In some embodiments, wherein the first area is located continuously along the two sides of a part of the first cover of the cell module which corresponds to each cell.

In some embodiments, wherein a width of the first area varies from 3 mm to 10 mm.

In some embodiments, herein the cells in the cell module are fixed onto the first cover of the cell module by glue.

In some embodiments, wherein the battery pack further comprising a cooling plate located between the second pack cover and a second cover of the cell module.

In some embodiments, wherein the cooling plate is fixed onto the second cover of the cell module by thermal glue.

In a second aspect, a method for forming a battery pack is provided, the battery pack including a first pack cover, a second pack cover and a cell module, the second pack cover sealed with the first pack cover to form a cavity to accommodate the cell module, characterized in that, the method at least including:
gluing, a second area on the first cover of the cell module onto the first pack cover;
welding, a first area on a first cover of the cell module onto the first pack cover.

In some embodiments, wherein the first area at least includes overhang area of a surface of the first cover of the cell module and/or uncoated area of a surface of the first cover of the cell module.

In some embodiments, wherein the second area is not overlapped with the first area.

In some embodiments, wherein a welding seam on the first area and/or the first pack cover is in a line shape or in a zigzag shape.

In some embodiments, wherein the first area is located at intervals along the two sides of a part of the first cover of the cell module which corresponds to each cell.

In some embodiments, wherein the first area is located continuously along the two sides of a part of the first cover of the cell module which corresponds to each cell.

In some embodiments, wherein a width of the first area varies from 3 mm to 10 mm.

In some embodiments, wherein the method further including:

gluing, a cooling plate on a second cover of the cell module.

In some embodiments, wherein the method further including:

gluing, a second pack cover to the cooling plate.

In a third aspect, an electric vehicle is provided, the electric vehicle includes a battery pack according to the first aspect of the embodiments.

According to various embodiments of the present disclosure, a first area on a first cover of the cell module is fixed onto the first pack cover by welding; a second area on the first cover of the cell module is fixed onto the first pack cover by glue. Therefore, welding of the cell module in addition to application of structural glue between cell module and EES upper cover will provide sufficient bonding to overcome mechanical loads. So it is expected to realize of higher volumetric energy density by removing the structural bars from EES, fulfillment of mechanical requirements (shock and vibration) and strong bonding of cell module to EES upper cover, higher installed energy in EES, longer driving range of electric vehicle and lower costs per EES.

### BRIEF DESCRIPTION OF THE DRAWINGS

The above and other aspects, features, and benefits of various embodiments of the disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 is a diagram which shows a common Pack structure;

FIG. 2 is a diagram which shows a Pack with latitudinal bars structure;

FIG. 3 is a diagram which shows a structure of the battery pack 100 in accordance with an embodiment of the present disclosure;

FIG. 4 is a diagram which shows an internal disassembly structure of the battery pack 100 in accordance with an embodiment of the present disclosure;

FIG. 5 is a diagram which shows a section view of a cell module 103 in accordance with an embodiment of the present disclosure;

FIG. 6 is an another diagram which shows a section view of a cell module 103 in accordance with an embodiment of the present disclosure;

FIG. 7 is a diagram which shows a section view of the first area in accordance with an embodiment of the present disclosure;

FIG. 8 is an another diagram which shows a section view of the first area in accordance with an embodiment of the present disclosure;

FIG. 9 is a diagram which shows a method for forming a battery pack in accordance with an embodiment of the present disclosure;

FIG. 10 is an another diagram which shows a method for forming a battery pack in accordance with an embodiment of the present disclosure.

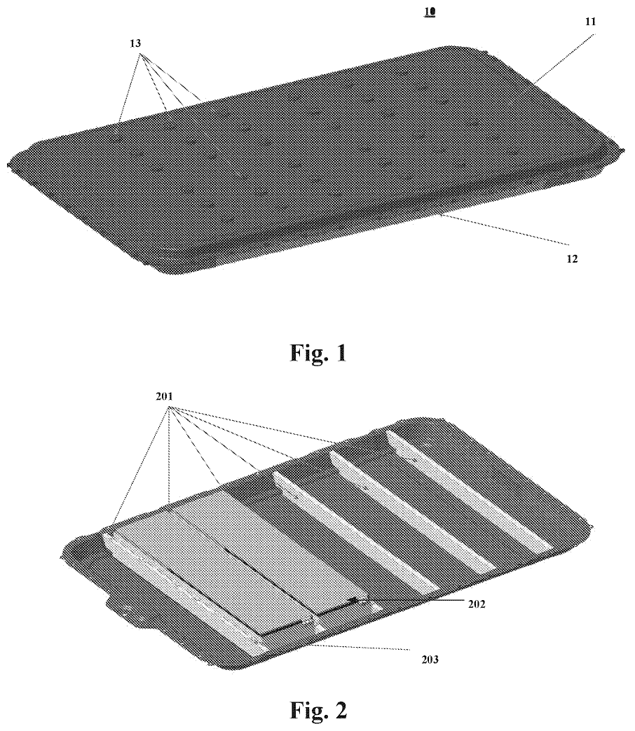

### DETAILED DESCRIPTION

The present disclosure will now be described with reference to several example embodiments. It should be understood that these embodiments are discussed only for the purpose of enabling those skilled persons in the art to better understand and thus implement the present disclosure, rather than suggesting any limitations on the scope of the present disclosure.

It should be understood that when an element is referred to as being “connected” or “coupled” or “contacted” to another element, it may be directly connected or coupled or contacted to the other element or intervening elements may be present. In contrast, when an element is referred to as being “directly connected” or “directly coupled” or “directly contacted” to another element, there are no intervening elements present. Other words used to describe the relationship between elements should be interpreted in a like fashion (e.g., “between” versus “directly between”, “adjacent” versus “directly adjacent”, etc.).

As used herein, the terms “first” and “second” refer to different elements. The singular forms “a” and “an” are intended to include the plural forms as well, unless the context clearly indicates otherwise. The terms “comprises,” “comprising,” “has,” “having,” “includes” and/or “including” as used herein, specify the presence of stated features, elements, and/or components and the like, but do not preclude the presence or addition of one or more other features, elements, components and/or combinations thereof.

The term “based on” is to be read as “based at least in part on”. The term “cover” is to be read as “at least in part cover”. The term “one embodiment” and “an embodiment” are to be read as “at least one embodiment”. The term “another embodiment” is to be read as “at least one other embodiment”. Other definitions, explicit and implicit, may be included below.

In this disclosure, unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

### A First Aspect of Embodiments

A battery pack is provided in the embodiments.

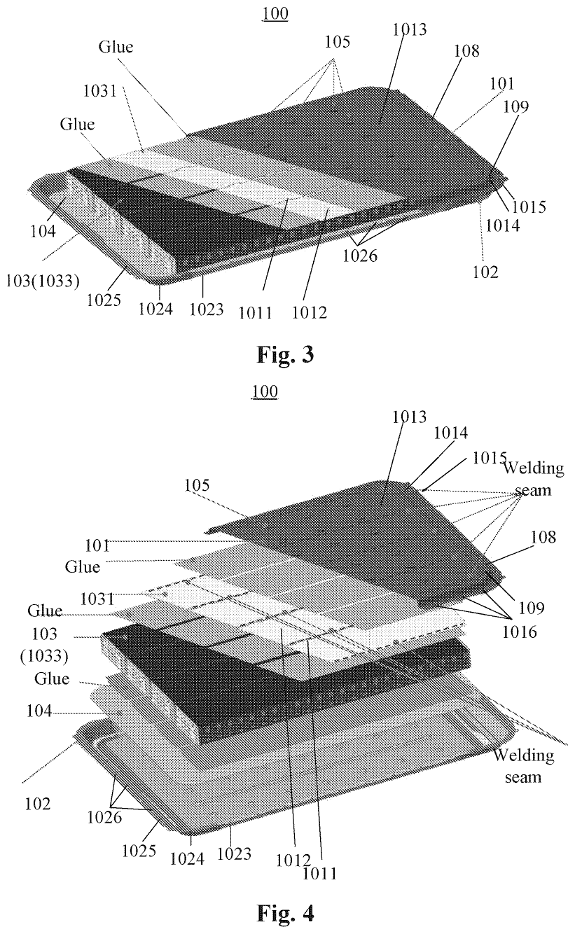

FIG. 3 is a diagram which shows a structure of the battery pack 100 in accordance with an embodiment of the present disclosure. FIG. 4 is a diagram which shows an internal disassembly structure of the battery pack 100 in accordance with an embodiment of the present disclosure.

As shown in FIG. 3 and FIG. 4, a battery pack 100 at least includes: a first pack cover 101, a second pack cover 102 and a cell module 103. The second pack cover 102 sealed with the first pack cover 101 to form a cavity to accommodate the cell module 103.

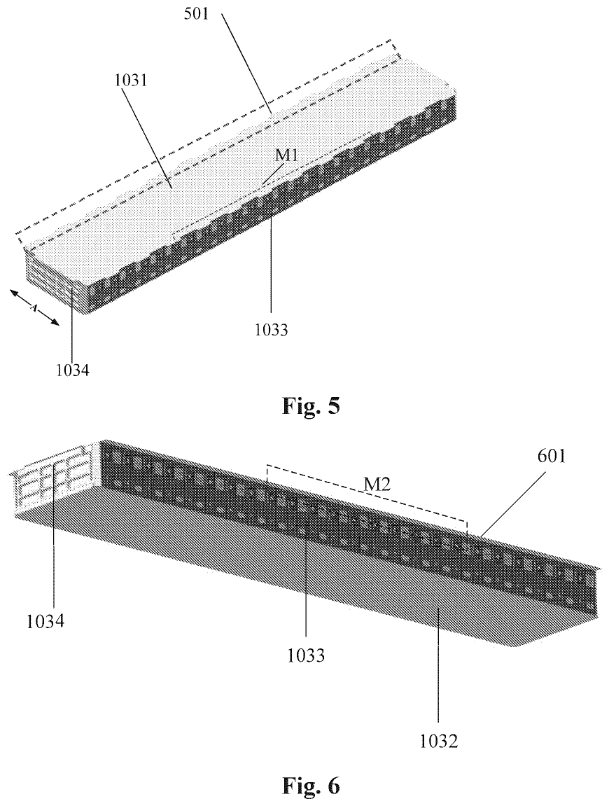

In this disclosure, a first area 1011 on a first cover 1031 of the cell module 103 is fixed onto the first pack cover 101 by welding; a second area 1012 (not shown in FIGS. 3 and 4, but shown in FIG. 5) on the first cover 1031 of the cell module 103 is fixed onto the first pack cover 101 by glue. Therefore, welding of the cell module in addition to application of structural glue between cell module and EES upper cover will provide sufficient bonding to overcome mechanical loads. So it is expected to realize of higher volumetric energy density by removing the structural bars from EES, fulfillment of mechanical requirements (shock and vibration) and strong bonding of cell module to EES upper cover, higher installed energy in EES, longer driving range of electric vehicle and lower costs per EES.

It should be appreciated that some components or elements are illustrated only as examples in FIG. 3 and FIG. 4. However, it is not limited thereto, for example, connections or positions of the components or elements may be adjusted, and/or, some components or elements may be omitted.

In some embodiments, as shown in FIG. 3, the first pack cover 101 (such as upper pack cover) includes a quadrilateral plate plane 1013, a side wall 1014 and a folded part 1015 extending around along the bottom end of the side wall 1014. The structure of the second pack cover (such as bottom pack cover) is similar to that of the first pack cover 101, that is, the second pack cover 102 includes a quadrilateral plate plane 1023, a side wall 1024 and a folded part 1025 extending around along the bottom end of the side wall 1024. For example, the first pack cover 101 bulges upward through the side wall 1014, the second pack cover 102 bugles downward through the side wall 1024. Therefore, it may provide bigger inner cavity space for the battery pack, to improve the volume of the battery pack.

In some embodiments, The folded part 1015 is provided with a number of mounting holes 1016, and the folded part 1025 at the position corresponding to the folded part 1015 is also provided with a number of mounting holes 1026. Fasteners such as bolts can successively pass through the first pack cover 101 and the second pack cover along the mounting holes, so as to fix the first pack cover 101 and the second pack cover 102. Furthermore, because the mounting holes are arranged at intervals along the folding part, it has little impact on the structural stiffness and structural performance of the first pack cover and the second pack cover, so as to ensure the stability of the first pack cover and the second pack cover.

In some embodiments, the first pack cover 101 and/or the second pack cover 102 has a plurality of edges 108 and corners 109. These edges 108 and corners 109 can be rounded, so that the edges and corners become smooth, which not only improves the aesthetics, but also increases the safety of the overall structure.

Next, some structures of the cell module will be illustrated as examples.

In some embodiments, the cell module 103 includes a plurality of cells 1033 arranged in parallel. The number of cells is designed on demand. Other structures in the battery pack, such as the structure between the cells and the internal structure of the cell, and other structures in the battery pack can refer to the relevant art, which is omitted here.

FIG. 5 and FIG. 6 are diagrams which show a section view of a cell module 103 in accordance with an embodiment of the present disclosure.

In some embodiments, as shown in FIG. 5 and FIG. 6, the cell module 103 further includes a first cover 1031 (such as upper cover of the cell module) and a second cover 1032 (such as bottom cover of the cell module). Furthermore, the cell module 103 includes an end plates 1034 on the two sides of the cell module 103. The first cover 1031 of the cell module 103 (such as a bottom surface of the upper cover of the cell module) is fixed onto the cells 1033 by glue.

In some embodiment, the first cover 1031 of the cell module 103 includes an overhang area and an non-overhang area. The overhang area is the non-overlapped area between the negative plate and the positive plate. The non-overhang area is the overlapped area between the negative plate and the positive plate. But it is not limited thereto, for example, the first cell cover 1031 includes an uncoated area and a coated area.

The following embodiments take the overhang area as an example, and the uncoated area is similar to the overhang area which is omitted here.

In some embodiments, the overhang area 501 protrudes (in a direction of A shown in FIG. 5) from the two sides of a part of the first cover of the cell module which corresponds to each cell. As shown in FIG. 5, the overhang area 501 is located at intervals along the two sides of a part of the first cover of the cell module which corresponds to each cell. In some embodiments, as shown in FIG. 6, the overhang area 601 is located continuously along the two sides of a part of the first cover of the cell module which corresponds to each cell. The width of the overhang can vary from 3 mm to 10 mm or higher, it is not limited thereto. It should be appreciated that the above embodiments of the overhang are illustrated only as examples in FIG. 5-6. However, it is not limited thereto. Other shape of the overhang is also applicable to the present application.

The fixation manner of the cell module and the first pack cover will be illustrated as examples below.

In some embodiments, the first pack cover 101 consists of a first area 1011 and a second area 1012. The second area 1012 is not overlapped with the first area 1011. For example, the first area at least includes the overhang area of a surface of the first cover of the cell module and/or the uncoated area of a surface of the first cover of the cell module. The second area at least includes the non-overhang area of a surface of the first cover of the cell module and/or the coated area of a surface of the first cover of the cell module.

In some embodiment, in order to enhance mechanical fixation, two fixation manner are adopted. For example, a first area 1011 on a first cover 1031 of the cell module 103 (such as upper surface of first cover 1031 of the cell module 103) is fixed onto the first pack cover 101 (such as bottom surface of the first pack cover) by welding; a second area 1012 on the first cover 1031 of the cell module 103 (such as upper surface of first cover 1031 of the cell module) is fixed onto the first pack cover 101 (such as bottom surface of the first pack cover) by glue. So the bonding of the cell module to the first pack cover will be enhanced, especially in Z-Axis.

Next, welding manner of the cell module and the first pack cover will be illustrated as examples.

In some embodiments, a laser is used to a first area 1011 onto the first pack cover 101 in a welding process, but it is not limited thereto. For example, other ways such as an ultrasonic may be used in the welding process.

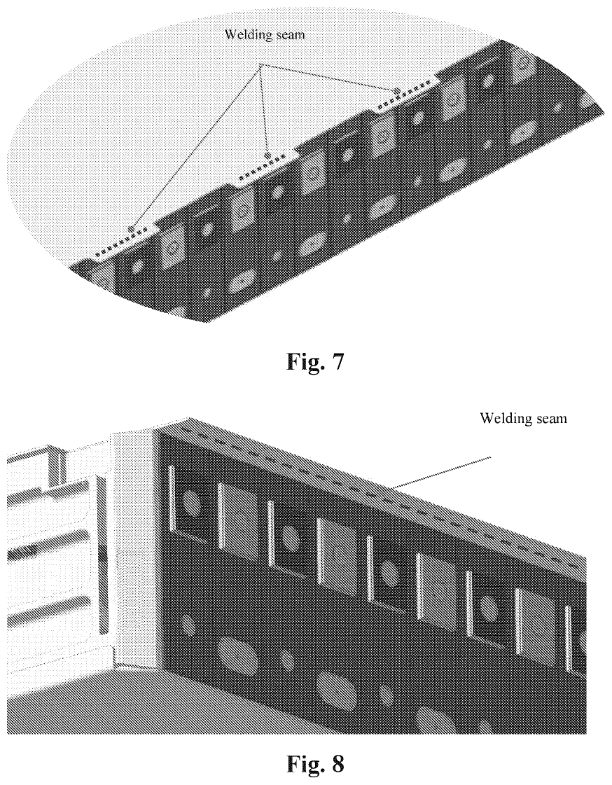

FIG. 7 is a diagram which shows a section view of the first area in accordance with an embodiment of the present disclosure. FIG. 8 is an another diagram which shows a section view of the first area in accordance with an embodiment of the present disclosure.

In some embodiments, a welding seam is applied onto the first area (such as overhang area or uncoated area). As shown in FIG. 7 and FIG. 8, the welding seam is in a line shape, but it is not limited thereto. Other shapes like zigzag could also be adopted.

In some embodiments, the first area only includes parts of the overhang area or uncoated area, the second area only includes parts of the non-overhang area or coated area, but it is not limited thereto, the first area may include all the overhang area or uncoated area. The second area may include all the non-overhang area or coated area. That is, the welding seam can be applied onto only parts of the overhang area or uncoated area or the welding seam can be applied onto all the overhang area or uncoated area. For example, as shown in FIG. 5, the welding seam can be applied onto each protrusion block, or the welding seam can be applied onto the protrusion block at intervals, but it is not limited thereto, the welding seam can be applied onto the middle protrusion block “M1”, as shown in FIG. 8, the welding seam can be applied onto the whole overhang area, or the welding seam can be applied onto the middle area “M2” of the overhang area. protrusion block at intervals.

In some embodiment, the second area can be covered by glue, that is, only parts of the non-overhang area or uncoated area are covered by glue or all the non-overhang area or coated area is covered by glue. As the second area is not overlapped with the first area, the first area are not supposed to be covered by glue, furthermore, the upper surface and the bottom surface of the first area (such as overhang area) are not covered by glue.

In some embodiments, a welding seam is also applied onto a third area of the first pack cover corresponding to the position of the first area of the first cover of the cell module. In other words, the position and the shape of the welding seam on the third area is corresponding to that of the welding seam of the first area which is omitted here. And a fourth area of a bottom surface of the first pack cover corresponding to the position of the second area is also covered by glue.

In some embodiments, the battery pack further includes a cooling plate 104 located between the second pack cover 102 and a second cover 1032 of the cell module 103, wherein the cooling plate is fixed onto the second cover of the cell module by thermal glue, so as to ensure good heat dissipation performance.

In some embodiments, the battery pack may be provided to a vehicle as a fuel source of the vehicle. As an example, the battery pack may be provided to an electric vehicle, a hybrid vehicle, and various other-type vehicles capable of using the battery pack as a fuel source.

In addition, the battery pack may be provided in other devices, instruments or facilities such as an energy storage system using a secondary battery, in addition to the vehicle.

It is to be understood that, the above examples or embodiments are discussed for illustration, rather than limitation. Those skilled in the art would appreciate that there may be many other embodiments or examples within the scope of the present disclosure.

It can be seen from the above embodiments, welding of the cell module in addition to application of structural glue between cell module and EES upper cover will provide sufficient bonding to overcome mechanical loads. So it is expected to realize of higher volumetric energy density by removing the structural bars from EES, fulfillment of mechanical requirements (shock and vibration) and strong bonding of cell module to EES upper cover, higher installed energy in EES, longer driving range of electric vehicle and lower costs per EES.

### A Second Aspect of Embodiments

A method for forming a battery pack is provided in the embodiments. The corresponding devices are illustrated in the first aspect of embodiments, and the same contents as those in the first aspect of embodiments are omitted.

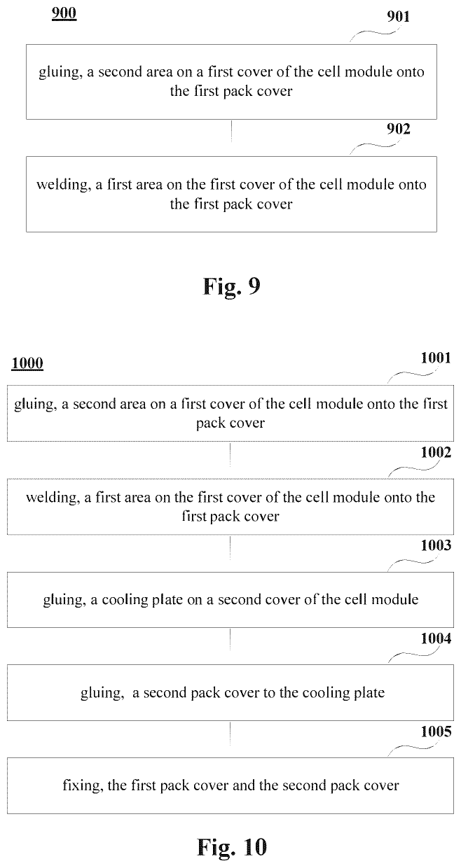

FIG. 9 is a diagram which shows a method for forming a battery pack in accordance with an embodiment of the present disclosure. As shown in FIG. 9, a method 900 for forming a battery pack includes:
901, gluing, a second area on the first cover of the cell module onto the first pack cover;
902, welding, a first area on a first cover of the cell module onto the first pack cover;

In some embodiments, the second area of a upper surface of the first cover of the cell module (such as upper cover of the cell module) is glued onto the bottom surface of the first pack cover (such as upper pack cover), the first area of the first cover of the cell module is welded to the first pack cover along the welding seam described in the above embodiments. Therefore, welding of the cell module in addition to application of structural glue between cell module and the first pack cover will provide sufficient bonding to overcome mechanical loads.

It should be appreciated that FIG. 9 is only an example of the disclosure, but it is not limited thereto. For example, the order of operations at blocks or steps may be adjusted, and/or, some blocks or steps may be omitted. Moreover, some blocks or steps not shown in FIG. 9 may be added.

The embodiments of the first area, second area, welding seam and so on may refer to the first aspect of embodiments which are omitted here.

FIG. 10 is a diagram which shows a method for forming a battery pack in accordance with an embodiment of the present disclosure. As shown in FIG. 10, a method 1000 for forming a battery pack includes:
1001, gluing, a second area on the first cover of the cell module onto the first pack cover;
1002, welding, a first area on a first cover of the cell module onto the first pack cover;

The embodiments of 1001-1002 may refer to 901-902 which are omitted here.

In some embodiments, the method further includes:
1003, gluing, a cooling plate on a second cover of the cell module;
1004, gluing, a second pack cover to the cooling plate.

In some embodiments, the method further includes:
1005, fixing, the first pack cover and the second pack cover.

For example, fasteners such as bolts can successively pass through the first pack cover and the second pack cover along the mounting holes on the folded part, so as to fix the first pack cover and the second pack cover.

It should be appreciated that FIG. 10 is only an example of the disclosure, but it is not limited thereto. For example, the order of operations at blocks or steps may be adjusted, and/or, some blocks or steps may be omitted. Moreover, some blocks or steps not shown in FIG. 10 may be added.

The details of the processes for assembling the cell module are omitted in this disclosure, and please refer to relevant art.

It can be seen from the above embodiments, welding of the cell module in addition to application of structural glue between cell module and EES upper cover will provide sufficient bonding to overcome mechanical loads. So it is expected to realize of higher volumetric energy density by removing the structural bars from EES, fulfillment of mechanical requirements (shock and vibration) and strong bonding of cell module to EES upper cover, higher installed energy in EES, longer driving range of electric vehicle and lower costs per EES.

### A Third Aspect of Embodiments

An electric vehicle is provided in the embodiments. The corresponding devices and the method are illustrated in the first and second aspects of embodiments, and the same contents as those in the first and second aspects of embodiments are omitted.

In some embodiments, the electric vehicle includes a battery pack. The battery pack is illustrated according to the first aspects of embodiments.

In some embodiments, the battery pack may be provided to a vehicle as a fuel source of the vehicle. As shown in FIG. 3, there are some bulges 105 on the upper surface of the first pack cover 101 which are used to fix the battery onto the vehicle underbody. The bulges can be arranged in a number of rows. The bulges in each row are arranged in a line, but it is not limited thereto.

In some embodiments, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (ICs) with minimal experimentation.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device.

While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

In some embodiments, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous.

Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A battery pack, at least comprising a first pack cover, a second pack cover and a cell module, the second pack cover sealed with the first pack cover to form a cavity to accommodate the cell module, wherein,
a first area on a first cover of the cell module is fixed onto the first pack cover by welding; and
a second area on the first cover of the cell module is fixed onto the first pack cover by glue.

2. The battery pack according to claim 1, wherein the first area at least comprises an overhang area of a surface of the first cover of the cell module and/or an uncoated area of a surface of the first cover of the cell module.

3. The battery pack according to claim 1, wherein the second area is not overlapped with the first area.

4. The battery pack according to claim 1, wherein a welding seam on the first area and/or the first pack cover is in a line shape or in a zigzag shape.

5. The battery pack according to claim 2, wherein the first area is located at intervals along two sides of a part of the first cover of the cell module which corresponds to each cell.

6. The battery pack according to claim 1, wherein the first area is located continuously along two sides of a part of the first cover of the cell module which corresponds to each cell.

7. The battery pack according to claim 1, wherein a width of the first area varies from 3 mm to 10 mm.

8. The battery pack according to claim 1, wherein cells in the cell module are fixed onto the first cover of the cell module by glue.

9. The battery pack according to claim 1, wherein the battery pack further comprising a cooling plate located between the second pack cover and a second cover of the cell module.

10. The battery pack according to claim 9, wherein the cooling plate is fixed onto the second cover of the cell module by thermal glue.

11. A method for forming a battery pack which comprising a first pack cover, a second pack cover and a cell module, the second pack cover sealed with the first pack cover to form a cavity to accommodate the cell module, wherein, the method at least comprising:
gluing, a second area on a first cover of the cell module onto the first pack cover; and
welding, a first area on the first cover of the cell module onto the first pack cover.

12. The method according to claim 11, wherein the first area at least comprises an overhang area of a surface of the first cover of the cell module and/or an uncoated area of a surface of the first cover of the cell module.

13. The method according to claim 11, wherein the second area is not overlapped with the first area.

14. The method according to claim 11, wherein a welding seam on the first area is in a line shape or in a zigzag shape.

15. The method according to claim 11, wherein the first area is located at intervals along two sides of a part of the first cover of the cell module which corresponds to each cell.

16. The method according to claim 11, wherein the first area is located continuously along two sides of a part of the first cover of the cell module which corresponds to each cell.

17. The method according to claim 11, wherein a width of the first area varies from 3 mm to 10 mm.

18. The method according to claim 11, wherein the method further comprising:
gluing, a cooling plate on a second cover of the cell module.

19. The method according to claim 11, wherein the method further comprising:
gluing, the second pack cover to the cooling plate.

20. An electric vehicle, comprising a battery pack according to claim 1.
